(19) United States
(12) Patent Application Publication
(10) Pub. No.: US 2026/0189272 A1
(43) Pub. Date: Jul. 2, 2026

(54) SYSTEMS AND METHODS FOR REDUCING LOSS AND DISTORTION FOR BEAMFORMING

(71) Applicant: Skyworks Solutions, Inc., Irvine, CA (US)

(72) Inventors: Lui Ray Lam, Lexington, MA (US); Sriramkumar Venugopalan, Campbell, CA (US)

(21) Appl. No.: 19/410,956

(22) Filed: Dec. 5, 2025

Related U.S. Application Data
(60) Provisional application No. 63/739,882, filed on Dec. 30, 2024.
(60) Provisional application No. 63/739,883, filed on Dec. 30, 2024.

(51) Int. Cl. H04B 7/0426; H04B 1/04; H04L 25/03

(52) U.S. Cl. CPC H04B 7/043; H04B 1/0475; H04L 25/03006; H04L 2025/03471

(57) ABSTRACT

Systems and methods for reducing loss and distortion for beamforming are provided. In one aspect, a radio transmitter includes an antenna array including a plurality of antennas and a transmit port configured to receive a radio frequency transmit signal. The radio transmitter further includes a plurality of delay circuits, each of the delay circuits configured to receive the radio frequency transmit signal from the transmit port and delay the radio frequency transmit signal. Each of the delay circuits is configured to provide the delayed radio transmit signal to a corresponding one of the antennas and each of the delay circuits includes a plurality of delay components electrically connected in series and a plurality of switches. Each of the switches is electrically connected in parallel with a corresponding one of the delay components.

### CROSS-REFERENCE TO RELATED APPLICATION(S)

This application claims the benefit of U.S. Provisional Application No. 63/739,882, filed Dec. 30, 2024 and the benefit of U.S. Provisional Application No. 63/739,883, filed Dec. 30, 2024. The foregoing applications are hereby incorporated by reference in their entireties. Any and all applications for which a foreign or domestic priority claim is identified in the Application Data Sheet as filed with the present application are hereby incorporated by reference under 37 CFR 1.57.

### BACKGROUND

### Field

Embodiments of this disclosure relate to systems and methods for beamforming, and in particular, to techniques for reducing loss and distortion.

### Description of the Related Technology

Beamforming technologies allow radio frequency transmit signals from multiple antennas to form a beam using constructive interference. In some cases, a delay can be introduced to the radio frequency transmit signal provided to the antennas to adjust the direction of the beam.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a radio transmitter comprising: an antenna array including a plurality of antennas; a transmit port configured to receive a radio frequency transmit signal; and a plurality of delay circuits, each of the delay circuits configured to receive the radio frequency transmit signal from the transmit port and delay the radio frequency transmit signal, each of the delay circuits configured to provide the delayed radio transmit signal to a corresponding one of the antennas, and each of the delay circuits including a plurality of delay components electrically connected in series and a plurality of switches, each of the switches electrically connected in parallel with a corresponding one of the delay components.

In some embodiments, each of the delay components is configured to introduce a different amount of delay to the radio frequency transmit signal.

In some embodiments, each of the delay circuits is further configured to introduce a total amount of delay into the radio frequency transmit signal by controlling a combination of the switches that are closed and opened.

In some embodiments, the total amount of delay includes a sum of the delays introduced by the delay circuits through which the radio frequency signal travels.

In some embodiments, each of the switches includes a different number of transistors arranged in series.

In some embodiments, a number of transistors included in each of the switches is based on the amount of delay introduced to the radio frequency signal by the corresponding one of the delay components.

In some embodiments, each of the delay components includes an added amount of insertion loss substantially the same as an insertion loss introduced by the corresponding switch.

In some embodiments, the radio transmitter further comprises a tilt control circuit configured to receive an input tilt value and control each of the delay circuits to delay the radio frequency transmit signal such that antenna array generates a radio frequency transmit beam having a tilt based on the input tilt value.

Another aspect is a base station comprising: an antenna array including a plurality of antennas configured to generate a radio frequency transmit beam having a tilt for wirelessly communicating with user equipment; a transmit port configured to receive a radio frequency transmit signal; and a plurality of delay circuits, each of the delay circuits configured to receive the radio frequency transmit signal from the transmit port and delay the radio frequency transmit signal, each of the delay circuits configured to provide the delayed radio transmit signal to a corresponding one of the antennas, and each of the delay circuits including a plurality of delay components electrically connected in series and a plurality of switches, each of the switches electrically connected in parallel with a corresponding one of the delay components.

In some embodiments, each of the delay components is configured to introduce a different amount of delay to the radio frequency transmit signal.

In some embodiments, each of the delay circuits is further configured to introduce a total amount of delay into the radio frequency transmit signal by controlling a combination of the switches that are closed and opened.

In some embodiments, the total amount of delay includes a sum of the delays introduced by the delay circuits through which the radio frequency signal travels.

In some embodiments, each of the switches includes a different number of transistors arranged in series.

In some embodiments, a number of transistors included in each of the switches is based on the amount of delay introduced to the radio frequency signal by the corresponding one of the delay components.

In some embodiments, each of the delay components includes an added amount of insertion loss substantially the same as an insertion loss introduced by the corresponding switch.

In some embodiments, the base station further comprises a tilt control circuit configured to receive an input tilt value and control each of the delay circuits to delay the radio frequency transmit signal such that antenna array generates a radio frequency transmit beam having a tilt based on the input tilt value.

Yet another aspect is a delay circuit for digital remote electric tilt comprising: a plurality of delay components electrically connected in series; a plurality of switches, each of the switches electrically connected in parallel with a corresponding one of the delay components; and a controller configured to control a combination of the switches that are closed and opened to control a tile of the digital remote electric tilt.

In some embodiments, each of the delay components is configured to introduce a different amount of delay to a radio frequency transmit signal.

In some embodiments, the controller is further configured to introduce a total amount of delay into a radio frequency transmit signal by controlling the combination of the switches that are closed and opened.

In some embodiments, the total amount of delay includes a sum of the delays introduced by the delay circuits through which the radio frequency signal travels.

Still yet another aspect is a delay circuit for digital remote electric tilt comprising: a plurality of delay components electrically connected in series, each of the delay components configured to introduce an amount of delay to a radio frequency signal; and a plurality of switches, each of the switches electrically connected in parallel with a corresponding one of the delay components, and each of the switches including a different number of transistors arranged in series.

In some embodiments, each of the delay components is further configured to introduce a different amount of delay to the radio frequency signal.

In some embodiments, a number of transistors included in each of the switches is based on the amount of delay introduced to the radio frequency signal by the corresponding one of the delay components.

In some embodiments, a number of transistors included in each of the switches is proportional to a largest voltage difference between the radio frequency signal input to the corresponding one of the delay components and the radio frequency signal delayed by the corresponding one of the delay components.

In some embodiments, the delay circuit further comprises a controller configured to introduce a total amount of delay into the radio frequency signal by controlling a combination of the switches that are closed and opened.

In some embodiments, the total amount of delay includes a sum of the delays introduced by the delay circuits through which the radio frequency signal travels.

In some embodiments, each of the delay components includes an added amount of insertion loss substantially the same as an insertion loss introduced by the corresponding switch.

In some embodiments, the delay circuit is configured to output the delayed radio frequency signal to an antenna of an antenna array to form a radio frequency transmit beam with a tilt based on the amount of delay.

Another aspect is a radio transmitter comprising: an antenna array including a plurality of antennas; a transmit port configured to receive a radio frequency transmit signal; and a plurality of delay circuits, each of the delay circuits including a plurality of delay components electrically connected in series, each of the delay components configured to introduce an amount of delay to the radio frequency signal, and a plurality of switches, each of the switches electrically connected in parallel with a corresponding one of the delay components, and each of the switches including a different number of transistors arranged in series.

In some embodiments, each of the delay components is further configured to introduce a different amount of delay to the radio frequency signal.

In some embodiments, a number of transistors included in each of the switches is based on the amount of delay introduced to the radio frequency signal by the corresponding one of the delay components.

In some embodiments, a number of transistors included in each of the switches is proportional to a largest voltage difference between the radio frequency transmit signal input to the corresponding one of the delay components and the radio frequency transmit signal delayed by the corresponding one of the delay components.

In some embodiments, the radio transmitter further comprises a controller configured to control each of the delay circuits to introduce a total amount of delay into the radio frequency transmit signal by controlling a combination of the switches that are closed and opened.

In some embodiments, a total amount of delay introduced by each of the delay circuits includes a sum of the delays introduced by the delay circuits through which the radio frequency signal travels.

In some embodiments, each of the delay components includes an added amount of insertion loss substantially the same as an insertion loss introduced by the corresponding switch.

In some embodiments, each of the delay circuits is configured to output the delayed radio frequency signal to an antenna of an antenna array to form a radio frequency transmit beam with a tilt based on the amount of delay.

Yet another aspect is a base station comprising: an antenna array including a plurality of antennas configured to generate a radio frequency transmit beam having a tilt for wirelessly communicating with user equipment; a transmit port configured to receive a radio frequency transmit signal; and a plurality of delay circuits, each of the delay circuits including a plurality of delay components electrically connected in series, each of the delay components configured to introduce an amount of delay to the radio frequency signal, and a plurality of switches, each of the switches electrically connected in parallel with a corresponding one of the delay components, and each of the switches including a different number of transistors arranged in series.

In some embodiments, each of the delay components is further configured to introduce a different amount of delay to the radio frequency signal.

In some embodiments, a number of transistors included in each of the switches is based on the amount of delay introduced to the radio frequency signal by the corresponding one of the delay components.

In some embodiments, a number of transistors included in each of the switches is proportional to a largest voltage difference between the radio frequency transmit signal input to the corresponding one of the delay components and the radio frequency signal delayed by the corresponding one of the delay components.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the disclosure. In the figures, each identical or nearly identical component that is illustrated in various figures is represented by a like numeral. For purposes of clarity, not every component may be labeled in every figure. In the figures:

FIG. 1 is a schematic diagram of one example of a communication network.

FIG. 2A is a schematic diagram of one example of a communication link using carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3A is a schematic diagram of one example of a communication system that operates with beamforming.

FIG. 3B is a schematic diagram of one example of beamforming to provide a transmit beam.

FIG. 3C is a schematic diagram of one example of beamforming to provide a receive beam.

FIG. 4A is a perspective view of one embodiment of a module that operates with beamforming.

FIG. 4B is a cross-section of the module of FIG. 4A taken along the lines 6B-6B.

FIG. 5 is a schematic diagram of one embodiment of a mobile device.

FIG. 6 is a schematic diagram of one example of a communication network including a base station configured to implement beam forming with a configurable tilt.

FIG. 7 is a schematic diagram of a simplified digital remote electric tilt (DRET) antenna array.

FIG. 8 is a schematic diagram of an example delay circuit.

FIG. 9 is a diagram illustrating the voltage swing that can be experienced on opposing sides of a delay component.

FIG. 10 is a schematic diagram of another example delay circuit.

FIG. 11 is a schematic diagram of an example switch that can be used in the delay circuit of FIGS. 8 and 10.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Base stations comprise a plurality of antennas configured to transmit radio frequency signals that can be received by user equipment. The antennas can be arranged into one or more arrays. The base station can transmit a radio frequency signal using two or more of the antennas to form a beam via constructive interference of the transmitted radio frequency signal.

In some circumstances, the coverage of the radio frequency transmit beam can be improved by adjusting the direction (also referred to as the tilt) of the beam. One technique for adjusting the beam tilt is to mechanically adjust the orientation of the antenna array. However, there are drawbacks to using mechanical adjustments, such as wear and tear on moving parts, the time required to make adjustments, etc. Another technique for adjusting the beam tilt is to use digital remote electric tilt (DRET). While there are man advantageous to using DRET, the isolation requirements for the switches used to implement DRET can introduce insertion loss and include a relatively large number of components for implementation. Aspects of this disclosure relate to a DRET architecture that can reduce insertion loss and/or involve fewer components than previous implementations.

### Radio Frequency Communication Background

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IoT), Vehicle-to-Everything (V2X), and High Power User Equipment (HPUE).

3GPP introduced Phase 1 of fifth generation (5G) technology in Release 15, and plans to introduce Phase 2 of 5G technology in Release 16 (targeted for 2019). Subsequent 3GPP releases will further evolve and expand 5G technology. 5G technology is also referred to herein as 5G New Radio (NR).

### Example Communication Networks and Wireless Communication Devices

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

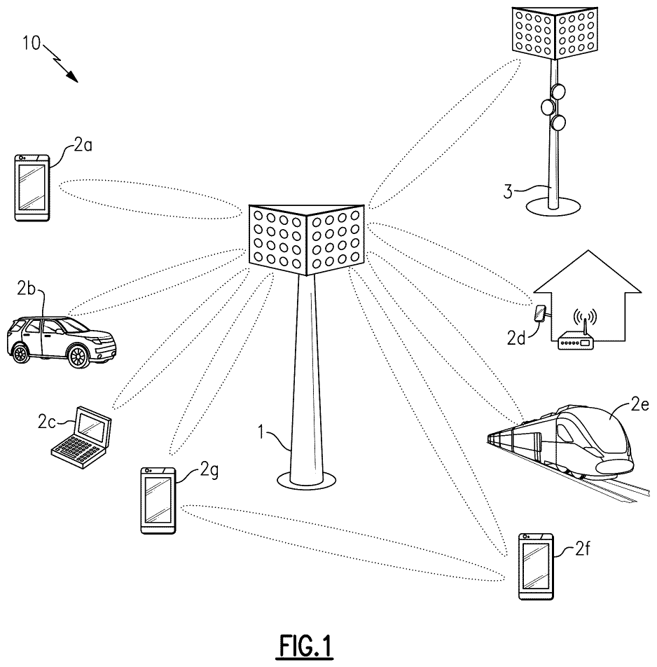

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul (for instance, as between mobile device 2g and mobile device 2f).

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1), Frequency Range 2 (FR2), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz.

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

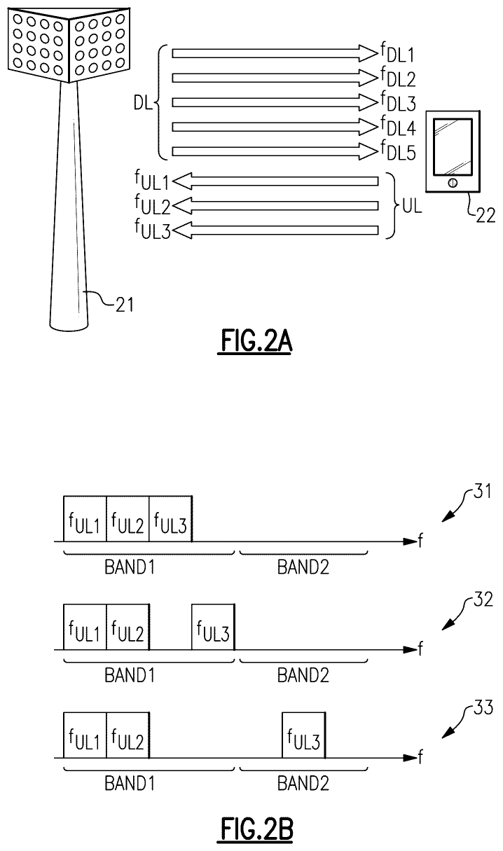

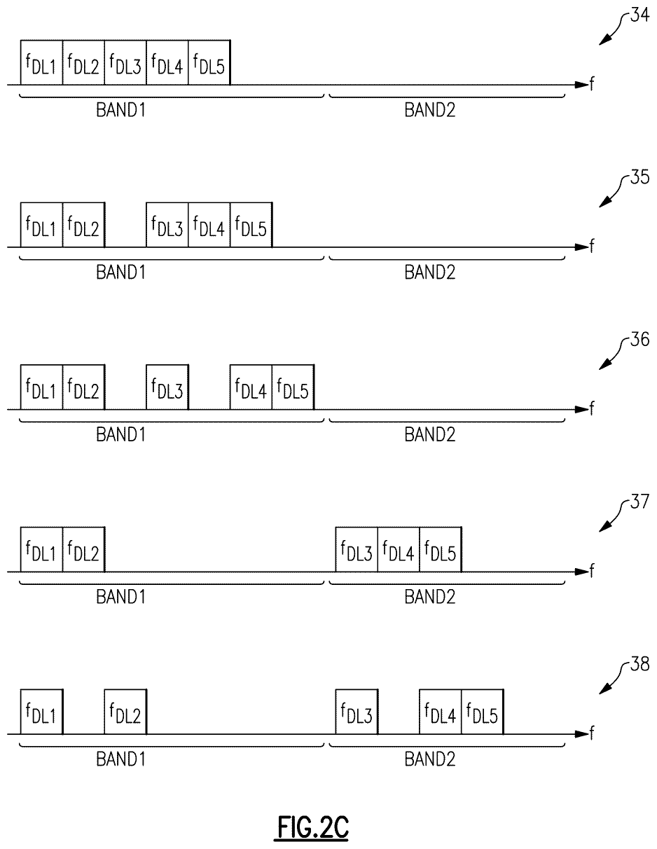

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2A, the uplink channel includes three aggregated component carriers f_{UL1}, f_{UL2}, and f_{UL3}. Additionally, the downlink channel includes five aggregated component carriers f_{DL1}, f_{DL2}, f_{DL3}, f_{DL4}, and f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier f_{UL1}, a second component carrier f_{UL2}, and a third component carrier f_{UL3}. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2}, and f_{UL3} that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers f_{UL1}, f_{UL2}, and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1} and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier f_{DL1}, a second component carrier f_{DL2}, a third component carrier f_{DL3}, a fourth component carrier f_{DL4}, and a fifth component carrier f_{DL5}. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and secondary cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink.

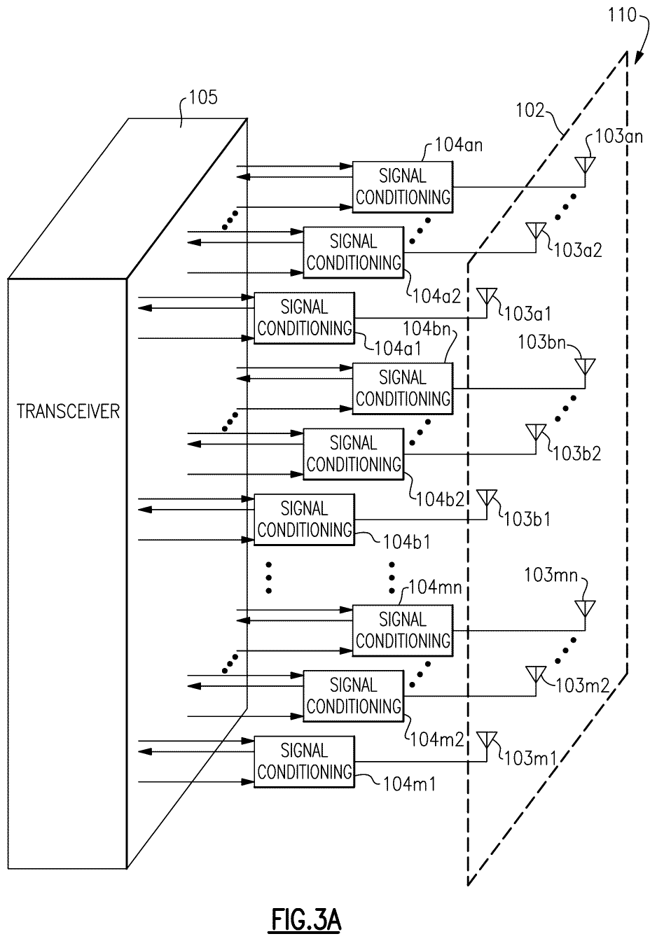

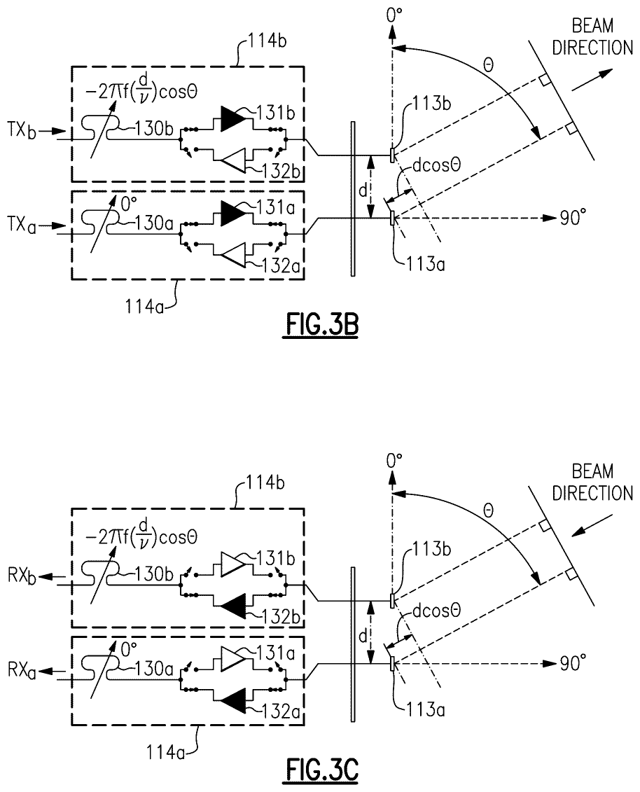

FIG. 3A is a schematic diagram of one example of a communication system 110 that operates with beamforming. The communication system 110 includes a transceiver 105, signal conditioning circuits 104a1, 104a2 . . . 104an, 104b1, 104b2 . . . 104bn, 104m1, 104m2 . . . 104mn, and an antenna array 102 that includes antenna elements 103a1, 103a2 . . . 103an, 103b1, 103b2 . . . 103bn, 103m1, 103m2 . . . 103mn.

Communications systems that communicate using millimeter wave carriers (for instance, 30 GHz to 300 GHz), centimeter wave carriers (for instance, 3 GHz to 30 GHz), and/or other frequency carriers can employ an antenna array to provide beam formation and directivity for transmission and/or reception of signals.

For example, in the illustrated embodiment, the communication system 110 includes an array 102 of m×n antenna elements, which are each controlled by a separate signal conditioning circuit, in this embodiment. As indicated by the ellipses, the communication system 110 can be implemented with any suitable number of antenna elements and signal conditioning circuits.

With respect to signal transmission, the signal conditioning circuits can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal is able to propagate for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits and processes signals received from the signal conditioning circuits. As shown in FIG. 3A, the transceiver 105 generates control signals for the signal conditioning circuits. The control signals can be used for a variety of functions, such as controlling the gain and phase of transmitted and/or received signals to control beamforming.

FIG. 3B is a schematic diagram of one example of beamforming to provide a transmit beam. FIG. 3B illustrates a portion of a communication system including a first signal conditioning circuit 114a, a second signal conditioning circuit 114b, a first antenna element 113a, and a second antenna element 113b.

Although illustrated as included two antenna elements and two signal conditioning circuits, a communication system can include additional antenna elements and/or signal conditioning circuits. For example, FIG. 3B illustrates one embodiment of a portion of the communication system 110 of FIG. 3A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 131b, a second LNA 132b, and switches for controlling selection of the power amplifier 131b or LNA 132b.

Although one embodiment of signal conditioning circuits is shown, other implementations of signal conditioning circuits are possible. For instance, in one example, a signal conditioning circuit includes one or more band filters, duplexers, and/or other components.

In the illustrated embodiment, the first antenna element 113a and the second antenna element 113b are separated by a distance d. Additionally, FIG. 3B has been annotated with an angle θ, which in this example has a value of about 90° when the transmit beam direction is substantially perpendicular to a plane of the antenna array and a value of about 0° when the transmit beam direction is substantially parallel to the plane of the antenna array.

By controlling the relative phase of the transmit signals provided to the antenna elements 113a, 113b, a desired transmit beam angle θ can be achieved. For example, when the first phase shifter 130a has a reference value of 0°, the second phase shifter 130b can be controlled to provide a phase shift of about −2πf(d/v)cosθ radians, where f is the fundamental frequency of the transmit signal, d is the distance between the antenna elements, v is the velocity of the radiated wave, and x is the mathematic constant pi.

In certain implementations, the distance d is implemented to be about ½λ, where λ is the wavelength of the fundamental component of the transmit signal. In such implementations, the second phase shifter 130b can be controlled to provide a phase shift of about −πcosθ radians to achieve a transmit beam angle θ.

Accordingly, the relative phase of the phase shifters 130a, 130b can be controlled to provide transmit beamforming. In certain implementations, a baseband processor and/or a transceiver (for example, the transceiver 105 of FIG. 3A) controls phase values of one or more phase shifters and gain values of one or more controllable amplifiers to control beamforming.

FIG. 3C is a schematic diagram of one example of beamforming to provide a receive beam. FIG. 3C is similar to FIG. 3B, except that FIG. 3C illustrates beamforming in the context of a receive beam rather than a transmit beam.

As shown in FIG. 3C, a relative phase difference between the first phase shifter 130a and the second phase shifter 130b can be selected to about equal to −2πf (d/v)cosθ radians to achieve a desired receive beam angle θ. In implementations in which the distance d corresponds to about ½λ, the phase difference can be selected to about equal to −cosθ radians to achieve a receive beam angle θ.

Although various equations for phase values to provide beamforming have been provided, other phase selection values are possible, such as phase values selected based on implementation of an antenna array, implementation of signal conditioning circuits, and/or a radio environment.

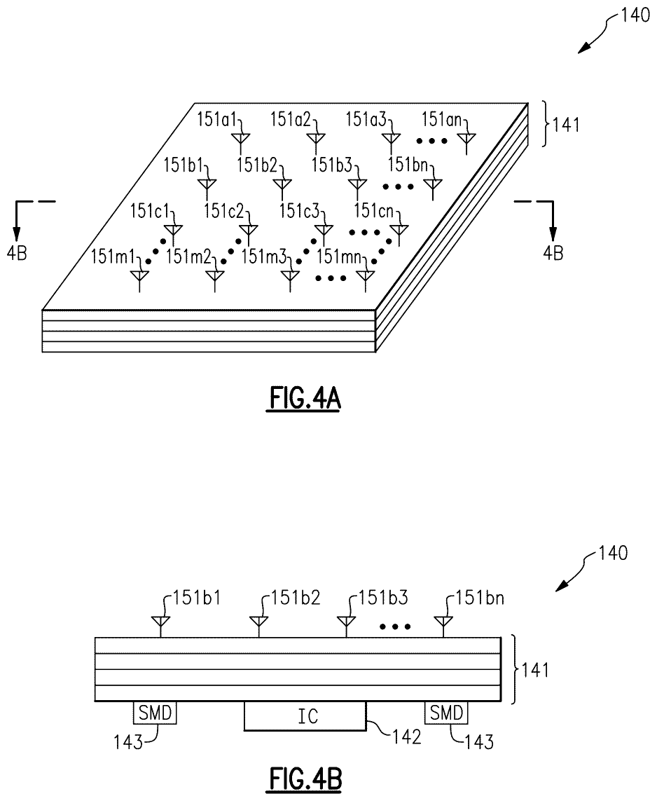

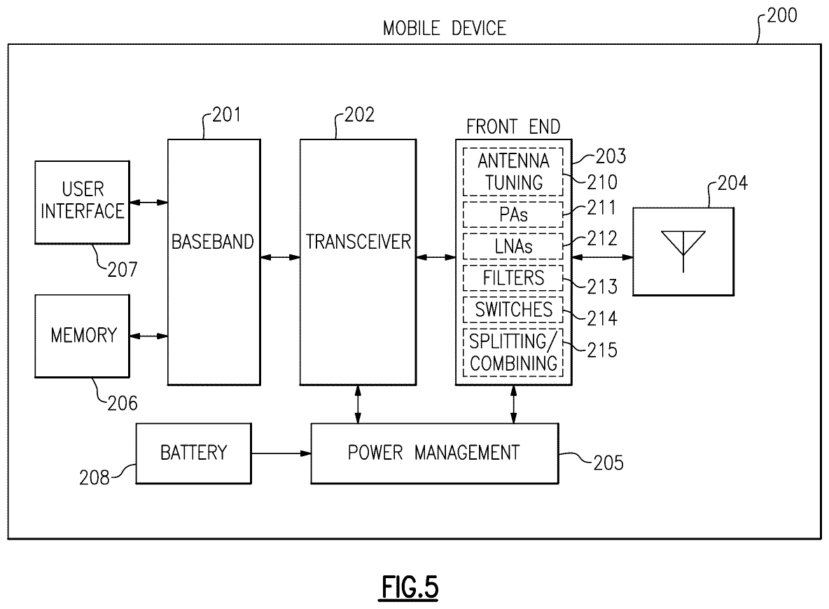

FIG. 4A is a perspective view of one embodiment of a module 140 that operates with beamforming. FIG. 4B is a cross-section of the module 140 of FIG. 4A taken along the lines 6B-6B.

The module 140 includes a laminated substrate or laminate 141, a semiconductor die or IC 142 (not visible in FIG. 4A), surface mount devices (SMDs) 143 (not visible in FIG. 4A), and an antenna array including antenna elements 151a1, 151a2, 151a3 . . . 151an, 151b1, 151b2, 151b3 . . . 151bn, 151c1, 151c2, 151c3 . . . 151cn, 151m1, 151m2, 151m3 . . . 151mn.

Although one embodiment of a module is shown in FIGS. 4A and 4B, the teachings herein are applicable to modules implemented in a wide variety of ways. For example, a module can include a different arrangement of and/or number of antenna elements, dies, and/or surface mount devices. Additionally, the module 140 can include additional structures and components including, but not limited to, encapsulation structures, shielding structures, and/or wirebonds.

The antenna elements antenna elements 151a1, 151a2, 151a3 . . . 151an, 151b1, 151b2, 151b3 . . . 151bn, 151c1, 151c2, 151c3 . . . 151cn, 151m1, 151m2, 151m3 . . . 151mn are formed on a first surface of the laminate 141, and can be used to receive and/or transmit signals, based on implementation. Although a 4×4 array of antenna elements is shown, more or fewer antenna elements are possible as indicated by ellipses. Moreover, antenna elements can be arrayed in other patterns or configurations, including, for instance, arrays using non-uniform arrangements of antenna elements. Furthermore, in another embodiment, multiple antenna arrays are provided, such as separate antenna arrays for transmit and receive and/or for different communication bands.

In the illustrated embodiment, the IC 142 is on a second surface of the laminate 141 opposite the first surface. However, other implementations are possible. In one example, the IC 142 is integrated internally to the laminate 141.

In certain implementations, the IC 142 includes signal conditioning circuits associated with the antenna elements 151a1, 151a2, 151a3 . . . 151an, 151b1, 151b2, 151b3 . . . 151bn, 151c1, 151c2, 151c3 . . . 151cn, 151m1, 151m2, 151m3 . . . 151mn. In one embodiment, the IC 142 includes a serial interface, such as a mobile industry processor interface radio frequency front-end (MIPI RFFE) bus and/or inter-integrated circuit (I2C) bus that receives data for controlling the signal conditioning circuits, such as the amount of phase shifting provided by phase shifters. In another embodiment, the IC 142 includes signal conditioning circuits associated with the antenna elements 151a1, 151a2, 151a3 . . . 151an, 151b1, 151b2, 151b3 . . . 151bn, 151c1, 151c2, 151c3 . . . 151cn, 151m1, 151m2, 151m3 . . . 151mn and an integrated transceiver.

The laminate 141 can include various structures including, for example, conductive layers, dielectric layers, and/or solder masks. The number of layers, layer thicknesses, and materials used to form the layers can be selected based on a wide variety of factors, and can vary with application and/or implementation. The laminate 141 can include vias for providing electrical connections to signal feeds and/or ground feeds of the antenna elements. For example, in certain implementations, vias can aid in providing electrical connections between signal conditioning circuits of the IC 142 and corresponding antenna elements.

The antenna elements 151a1, 151a2, 151a3 . . . 151an, 151b1, 151b2, 151b3 . . . 151bn, 151c1, 151c2, 151c3 . . . 151cn, 151m1, 151m2, 151m3 . . . 151mn can correspond to antenna elements implemented in a wide variety of ways. In one example, the array of antenna elements includes patch antenna element formed from a patterned conductive layer on the first side of the laminate 141, with a ground plane formed using a conductive layer on opposing side of the laminate 141 or internal to the laminate 141. Other examples of antenna elements include, but are not limited to, dipole antenna elements, ceramic resonators, stamped metal antennas, and/or laser direct structuring antennas.

The module 140 can be included in a communication system, such as a mobile phone or base station. In one example, the module 140 is attached to a phone board of a mobile phone.

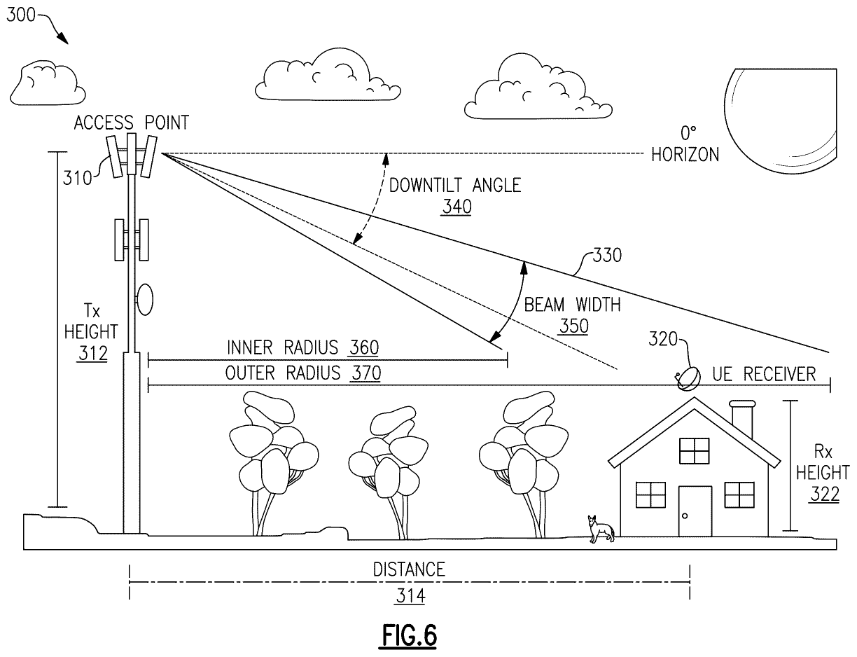

FIG. 5 is a schematic diagram of one embodiment of a mobile device 200. The mobile device 200 includes a baseband system 201, a transceiver 202, a front end system 203, antennas 204, a power management system 205, a memory 206, a user interface 207, and a battery 208.

The mobile device 200 can be used communicate using a wide variety of communications technologies, including, but not limited to, 2G, 3G, 4G (including LTE, LTE-Advanced, and LTE-Advanced Pro), 5G NR, WLAN (for instance, WiFi), WPAN (for instance, Bluetooth and ZigBee), WMAN (for instance, WiMax), and/or GPS technologies.

The transceiver 202 generates RF signals for transmission and processes incoming RF signals received from the antennas 204. It will be understood that various functionalities associated with the transmission and receiving of RF signals can be achieved by one or more components that are collectively represented in FIG. 5 as the transceiver 202. In one example, separate components (for instance, separate circuits or dies) can be provided for handling certain types of RF signals.

The front end system 203 aids in conditioning signals transmitted to and/or received from the antennas 204. In the illustrated embodiment, the front end system 203 includes antenna tuning circuitry 210, power amplifiers (PAS) 211, low noise amplifiers (LNAs) 212, filters 213, switches 214, and signal splitting/combining circuitry 215. However, other implementations are possible.

For example, the front end system 203 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 200 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 204 can include antennas used for a wide variety of types of communications. For example, the antennas 204 can include antennas for transmitting and/or receiving signals associated with a wide variety of frequencies and communications standards.

In certain implementations, the antennas 204 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 200 can operate with beamforming in certain implementations. For example, the front end system 203 can include amplifiers having controllable gain and phase shifters having controllable phase to provide beam formation and directivity for transmission and/or reception of signals using the antennas 204. For example, in the context of signal transmission, the amplitude and phases of the transmit signals provided to the antennas 204 are controlled such that radiated signals from the antennas 204 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 204 from a particular direction. In certain implementations, the antennas 204 include one or more arrays of antenna elements to enhance beamforming.

The baseband system 201 is coupled to the user interface 207 to facilitate processing of various user input and output (I/O), such as voice and data. The baseband system 201 provides the transceiver 202 with digital representations of transmit signals, which the transceiver 202 processes to generate RF signals for transmission. The baseband system 201 also processes digital representations of received signals provided by the transceiver 202. As shown in FIG. 5, the baseband system 201 is coupled to the memory 206 of facilitate operation of the mobile device 200.

The memory 206 can be used for a wide variety of purposes, such as storing data and/or instructions to facilitate the operation of the mobile device 200 and/or to provide storage of user information.

The power management system 205 provides a number of power management functions of the mobile device 200. In certain implementations, the power management system 205 includes a PA supply control circuit that controls the supply voltages of the power amplifiers 211. For example, the power management system 205 can be configured to change the supply voltage(s) provided to one or more of the power amplifiers 211 to improve efficiency, such as power added efficiency (PAE).

As shown in FIG. 5, the power management system 205 receives a battery voltage from the battery 208. The battery 208 can be any suitable battery for use in the mobile device 200, including, for example, a lithium-ion battery.

### Systems and Methods For Low Loss And Low Distortion Beam Tilt

Aspects of this disclosure relate to systems and techniques for reducing insertion loss and/or simplifying the circuit implementation of DRET. One application for DRET is within a base station and can be used to transmit radio frequency signals to user equipment. While aspects of this disclosure will be described in connection with the example of a base station configuration, this disclosure can also be used for DRET when included in other applications, such as, in user equipment, WiFi routers/switches, or any other wireless transmitter including an array of antennas.

FIG. 6 is a schematic diagram of one example of a communication network including a base station configured to implement beam forming with a configurable tilt. With reference to FIG. 6, the communication network 300 includes a base station 310 (also referred to as an access point) and a user equipment receiver 320. The base station 310 can be located at a first height 312 from the ground and a distance 314 from the user equipment receiver 320. The user equipment receiver 320 can be located at a second height 322 from the ground. The base station 310 can be configured to generate a radio frequency transmit beam 330 having a downtilt angle 340 with respect to the horizon and a beam width 350. The beam width 350 may have an inner radius 360 and an outer radius 370 at the second height 322.

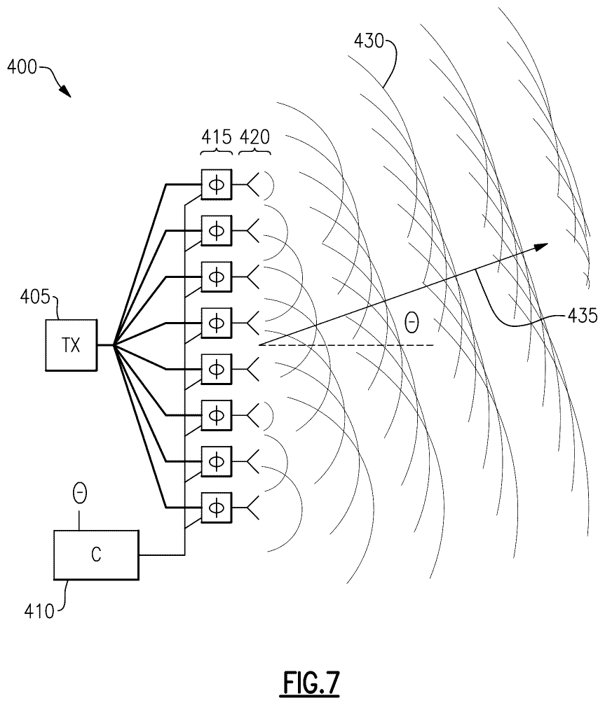

In order to increase the power of the beam received at the user equipment receiver 320, the base station 310 can be configured to tilt the direction in which the beam is aimed such that the user equipment receiver 320 falls within the beam width 350. When the title is achieved using DRET, delays can be introduced to the radio frequency transmit signal provided to the antennas of the antenna array to form a beam with a predetermined tilt as shown in FIG. 7.

FIG. 7 is a schematic diagram of a simplified DRET antenna array 400. The DRET antenna array 400 includes a transmit port 405, a tilt control circuit 410, a plurality of delay circuits 415, and an array of antennas 420. The transmit port 405 is configured to receive a radio frequency transmit signal and provide the radio frequency transmit signal to each of the delay circuits 415. The tilt control circuit 410 is configured to receive an input tilt value θ and control an amount of delay introduced by each of the plurality of delay circuits 415 based on the input tilt value θ. Each of the delay circuits 415 is configured to delay the radio frequency transmit signal by an amount configured to achieve an amount of tilt based on the input tilt value θ.

In the example shown in FIG. 7, the amount of delay introduced to the radio frequency transmit signal increases for each antenna 420 starting from the lower most antenna towards the top of the figure. By precisely controlling the amount of delay introduced by each of the plurality of delay circuits 415 using the tilt control circuit 410, the direction 435 of the generated radio frequency transmit beam 430 can form an angle θ with respect to horizontal substantially equal to the input tilt value θ.

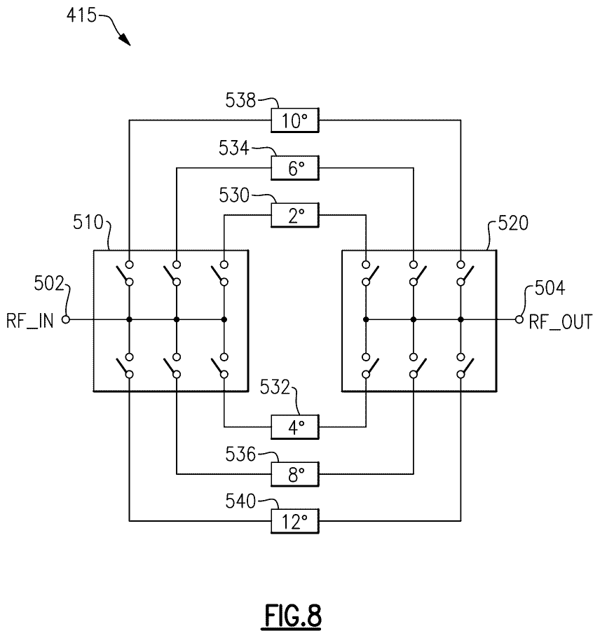

FIG. 8 is a schematic diagram of an example delay circuit 415. The delay circuit 415 includes a radio frequency input terminal 502, a radio frequency output termina 504, an input switch 510, an output switch 520, and a plurality of delay components 530, 532, 534, 536, 538, and 540. Each of the delay components 530-540 can be configured to introduce a defined amount of delay to the RF signal received at an input of the delay components 530-540. In the example of FIG. 8, each of the delay components 530-540 is configured to introduce an amount of delay corresponding to 2°, 4°, 6°, 8°, 10°, and 12° of tilt of the beam.

The input switch 510 is configured to receive a radio frequency input signal RF_IN from the radio frequency input terminal 502 and provide the radio frequency input signal RF_IN to one of the delay components 530-540. Similarly, the output switch 520 is configured to receive the delayed radio frequency input signal from the one of the delay components 530-540 and output the delayed radio frequency input signal to the radio frequency output termina 504 as a radio frequency output signal RF_OUT.

In the embodiment of FIG. 8, the input switch 510 and the output switch 520 can be implemented as single pole six throw (SP6T) switches. In other embodiments, the input and output switches 510, 520 can be implemented with a different number of throws, depending on the number of delay components 530-540 included in the delay circuit 415.

There are certain drawbacks to the delay circuit 415 design of FIG. 8. For example, the input and output switches 510, 520 are relatively large to ensure that the high power high voltage swing of the radio frequency signal does not leak through the paths of the input and output switches 510, 520 that are turned off. The relatively large size of the input and output switches 510, 520 leads to distortion and/or insertion loss. In addition, hot switching of the input and output switches 510, 520 can generate relatively strong transient impendence mismatch, which can result in damage to the connected power amplifier and/or DRET switch.

Each phase delay path (e.g., each path between the input switch 510 and the output switch 520 including one of the delay components 530-540) will receive the full signal voltage swing of the radio frequency signal. Thus, each phase delay path that is turned off is designed to ensure that the full signal voltage swing does not result in any leakage through the input and output switches 510, 520. This can be achieved by using a stack of N transistors, where the cumulative breakdown voltage of the stack of transistors is greater than the voltage swing of the radio frequency signal.

Accordingly, for any phase delay path, the radio frequency signal will pass through both the input switch 510 and the output switch 520, and thus, the radio frequency signal passes through 2N transistors. In addition, each of the input and output switches 510, 520 will have the remaining five throws in the off state, for a total of ten off arms loading the signal path.

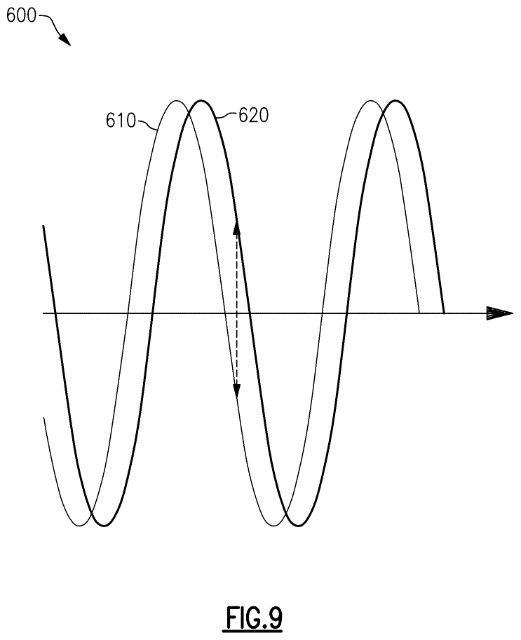

FIG. 9 is a diagram 600 illustrating the voltage swing that can be experienced on opposing sides of a delay component (e.g., one of the delay components 530-540 shown in FIG. 8). As shown in FIG. 9, a delay component can receive a first radio frequency signal 610 at an input of the delay component and output a second radio frequency signal 620, which is a delayed version of the first radio frequency signal 610. Thus, the voltage difference between the input and the output of the delay component is the difference in voltage between the first radio frequency signal 610 and the second radio frequency signal 620.

In the diagram 600, the first radio frequency signal 610 and the second radio frequency signal 620 are modeled as identical sine waves with a unit amplitude of one and a phase difference of θ. As can be seen from FIG. 9, the largest voltage difference between the first and second radio frequency signals 610 and 620 is at the zero crossing (e.g., sin (θ/2)−sin (−θ/2)=sin (θ/2)). Table 1 shows the largest voltage difference between the first and second radio frequency signals 610 and 620 for various values of the phase difference of θ.

TABLE 1

| θ | 2 sin(θ/2) |
|---|---|
| 2 | 0.034906 |
| 4 | 0.069801 |
| 6 | 0.104675 |
| 8 | 0.139517 |
| 10 | 0.174317 |
| 12 | 0.209064 |

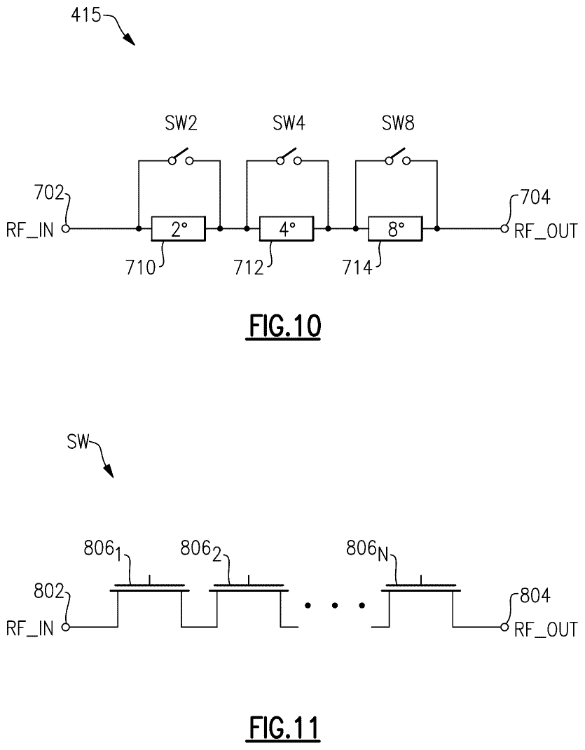

FIG. 10 is a schematic diagram of another example delay circuit 415. The delay circuit 415 includes a radio frequency input terminal 702, a radio frequency output terminal 704, a first switch SW2, a second switch SW4, a third switch SW8, a first delay component 710, a second delay component 712, and a third delay component 714. The radio frequency input terminal 702 is configured to receive a radio frequency input signal RF_IN and the radio frequency output termina 704 is configured to output a radio frequency output signal RF_OUT. In some embodiments, each of the delay components 710-714 is configured to introduce an amount of delay to any signal passing through the corresponding delay component 710-714. In some embodiments, each of the delay components 710-714 is configured to introduce a fixed amount of delay. In some embodiments, each of the delay components 710-714 is configured to introduce a different amount of delay. For example, in the embodiment of FIG. 10, the first delay component 710 is configured to introduce an amount of delay corresponding to a 2° tilt of the beam, the second delay component 712 is configured to introduce an amount of delay corresponding to a 4° tilt of the beam, and the third delay component 714 is configured to introduce an amount of delay corresponding to an 8° tilt of the beam.

The delay circuit 415 can be controlled (e.g., via a control circuit such as the tilt control circuit 410 of FIG. 7) to introduce a delay into the radio frequency input signal RF_IN having any combination of the first to third delay components 710-714. For example, when all three switches SW2-SW8 are open, each of the first to third delay components 710-714 will introduce a corresponding delay to the sum of the delays introduced by the first to third delay components 710-714. That is, the total delay introduced by the first to third delay components 710-714 will be an amount of delay corresponding to 2°+4°+8°=14° of tilt to the beam. The delay circuit 415 can introduce an amount of delay corresponding to 2°, 4°, 6°, 8°, 10°, 12°, and 14° of tilt of the beam based on different combinations of the first to third delay components 710-714. Thus, the embodiment of FIG. 10 is configured to provide 7 different phase combinations, which is one more combination than the delay circuit 415 of FIG. 8. The delay circuit 415 can also be configured to introduce substantially no delay into the radio frequency input signal RF_IN when all of the first to third switches SW2-SW8 are closed. Thus, the delay circuit 415 can be also configured to provide substantially no tilt to the beam.

FIG. 11 is a schematic diagram of an example switch SW that can be used in the delay circuit 415 of FIGS. 8 and 10. As shown in FIG. 11, the switch can include an input terminal 802, an output terminal 804, and a plurality of transistors 806₁, 806₂, . . . 806_{N}. Although the transistors 806₁, 806₂, . . . 806_{N} are illustrated as FETs, any suitable transistors can be used to implement the switch SW without departing from aspects of this disclosure. Each of the transistors 806 is configured to withstand a voltage differential (e.g., a breakdown voltage) between the terminals of the transistor 806 without any significant leakage of current through the transistor 806. In order to withstand the full voltage swing of a radio frequency signal (e.g., the first radio frequency signal 610 of FIG. 9), the switch SW can be implemented with a stack of N transistors 806₁, 806₂, . . . 806_{N} such that the sum of the breakdown voltages of the stack of N transistors 806₁, 806₂, . . . 806_{N} exceeds the full voltage swing of the radio frequency signal.

As described in connection with FIG. 9, the maximum voltage swing that each of the switches SW2, SW4, and SW8 in the delay circuit 415 of FIG. 10 will experience is based on the amount of delay introduced into the radio frequency signal by the corresponding delay component 710-714. Thus, the switches SW2, SW4, and SW8 can be implemented with a fewer number of transistors than a switch SW with N transistors configured to withstand the full voltage swing of the radio frequency signal. For example, the number of transistors included in each of the switches SW2-SW8 may be substantially proportional to a largest voltage difference between the radio frequency signal input to the corresponding one of the delay components 710-714 and the radio frequency signal delayed by the corresponding one of the delay components 710-714.

In some embodiments, the first switch SW2 can be implemented with 0.035 N transistors, the second switch SW4 can be implemented with 0.07 N transistors, and the third switch SW8 can be implemented with 0.14 N transistors. In the worst case scenario for the delay circuit 415 of FIG. 10 (e.g., substantially no delay), the radio frequency signal will travel through each of the switches SW2, SW4, and SW8, resulting in the radio frequency signal travelling through (0.035+0.07+0.14) N=0.245 N FETs. Compared to the worst case scenario number of FETs a radio frequency signal would travel through in the delay circuit 415 of FIG. 8, the radio frequency signal travels through slightly less than ⅛ the number of FETs in the worst case scenario of FIG. 10. Advantageously, the fewer number of FETs that the radio frequency signal travels through reduces the amount of insertion loss introduced into the radio frequency signal.

With continued reference to FIG. 10, when any one of the switches SW2, SW4, and SW8 is off, the switch SW2, SW4, or SW8 does not load the radio frequency signal to ground. The switches SW2, SW4, and SW8 that are turned off may introduce a certain amount of phase error to the radio frequency signal travelling through the delay circuit 415. To compensate for this phase error, a trace delay can be introduced into the wire trace connected to the switches SW2, SW4, or SW8.

Advantageously, by using the delay circuit 415 illustrated in FIG. 10 rather than the delay circuit 415 of FIG. 8, the delay circuit 415 can provide an about 8X insertion loss improvement (e.g., introduce significantly less distortion into the radio frequency signal). The delay circuit 415 of FIG. 10 can also provide a reduction in the area occupied by the delay circuit 415 (e.g., due to fewer delay components and fewer FETs in the switches) compared to the embodiment of FIG. 8.

In some embodiments, the insertion loss introduced by each of the switches SW2-SW8 may not be the same as the amount of insertion loss introduced by the corresponding delay components 710-714. Therefore, the insertion loss introduced into the radio frequency signal may vary depending on the total amount of delay introduced by the delay circuit 415 (e.g., the combination of delay components 710-714 switched into the path of the radio frequency signal).

In order to mitigate this variation in insertion loss, a certain amount of insertion loss can be added to each to the delay components 710-714 to match the insertion loss introduced by the corresponding switch SW2-SW8 (e.g., the insertion loss of first delay component 710 is configured to be substantially the same as the insertion loss of the first switch SW2). With these added losses, the insertion loss will be substantially the same regardless of the amount of delay introduced by the delay circuit 415. Since the wire trace lengths for implementing the delay circuit 415 of FIG. 10 are relatively shorter than the wire trace lengths used to implement the delay circuit 415 of FIG. 8, the compensation for the insertion loss variations in the delay circuit 415 of FIG. 10 is relatively simpler, leading to less overall variation in insertion loss.

Yet another advantage to the delay circuit 415 of FIG. 10 is that the impedance of the delay circuit 415 is independent of the state of the switches SW2-SW8 and the timing at which the switches SW2-SW8 are toggled. Thus, any misalignment in the timing of toggling the switches SW2-SW8 will only change the delay introduced to the radio frequency signal, but not the impedance of the delay circuit 415. In contrast, other implementations (such as the delay circuit 415 of FIG. 8), if the input switch 510 and the output switch 520 are not toggled at substantially the same rate, or if the selection arms are not handed off with sufficient accuracy, it will significantly change the input/output impedance from a nominal value (e.g., 50 Ohm). This mismatch can be as bad as a full open or direct short to ground. This can result in damage to a connected power amplifier and/or create excessive heat in the delay circuit 415.

In some embodiments, rather than implementing the switches SW2-SW8 by the embodiment shown in FIG. 11, in other embodiments, the switches SW2-SW8 can be implemented using mechanical switches.

### CONCLUSION

Aspects of this disclosure can be implemented in various electronic devices. Examples of the electronic devices can include, but are not limited to, consumer electronic products, parts of the consumer electronic products such as packaged radio frequency modules, uplink wireless communication devices, wireless communication infrastructure, electronic test equipment, etc. Examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a tablet computer, a microwave, a refrigerator, a vehicular electronics system such as an automotive electronics system, a stereo system, a digital music player, a radio, a camera such as a digital camera, a portable memory chip, a washer, a dryer, a washer/dryer, a copier, a facsimile machine, a scanner, a multi-functional peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel resonators described herein may be embodied in a variety of other forms. Furthermore, various omissions, substitutions and changes in the form of the resonators described herein may be made without departing from the spirit of the disclosure. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A radio transmitter comprising:
an antenna array including a plurality of antennas;
a transmit port configured to receive a radio frequency transmit signal; and
a plurality of delay circuits, each of the delay circuits configured to receive the radio frequency transmit signal from the transmit port and delay the radio frequency transmit signal, each of the delay circuits configured to provide the delayed radio transmit signal to a corresponding one of the antennas, and each of the delay circuits including a plurality of delay components electrically connected in series and a plurality of switches, each of the switches electrically connected in parallel with a corresponding one of the delay components.

2. The radio transmitter of claim 1 wherein each of the delay components is configured to introduce a different amount of delay to the radio frequency transmit signal.

3. The radio transmitter of claim 1 wherein each of the delay circuits is further configured to introduce a total amount of delay into the radio frequency transmit signal by controlling a combination of the switches that are closed and opened.

4. The radio transmitter of claim 3 wherein the total amount of delay includes a sum of the delays introduced by the delay circuits through which the radio frequency signal travels.

5. The radio transmitter of claim 1 wherein each of the switches includes a different number of transistors arranged in series.

6. The radio transmitter of claim 1 wherein a number of transistors included in each of the switches is based on the amount of delay introduced to the radio frequency signal by the corresponding one of the delay components.

7. The radio transmitter of claim 1 wherein each of the delay components includes an added amount of insertion loss substantially the same as an insertion loss introduced by the corresponding switch.

8. The radio transmitter of claim 1 further comprising a tilt control circuit configured to receive an input tilt value and control each of the delay circuits to delay the radio frequency transmit signal such that antenna array generates a radio frequency transmit beam having a tilt based on the input tilt value.

9. A base station comprising:
an antenna array including a plurality of antennas configured to generate a radio frequency transmit beam having a tilt for wirelessly communicating with user equipment;
a transmit port configured to receive a radio frequency transmit signal; and
a plurality of delay circuits, each of the delay circuits configured to receive the radio frequency transmit signal from the transmit port and delay the radio frequency transmit signal, each of the delay circuits configured to provide the delayed radio transmit signal to a corresponding one of the antennas, and each of the delay circuits including a plurality of delay components electrically connected in series and a plurality of switches, each of the switches electrically connected in parallel with a corresponding one of the delay components.

10. The base station of claim 9 wherein each of the delay components is configured to introduce a different amount of delay to the radio frequency transmit signal.

11. The base station of claim 9 wherein each of the delay circuits is further configured to introduce a total amount of delay into the radio frequency transmit signal by controlling a combination of the switches that are closed and opened.

12. The base station of claim 11 wherein the total amount of delay includes a sum of the delays introduced by the delay circuits through which the radio frequency signal travels.

13. The base station of claim 9 wherein each of the switches includes a different number of transistors arranged in series.

14. The base station of claim 9 wherein a number of transistors included in each of the switches is based on the amount of delay introduced to the radio frequency signal by the corresponding one of the delay components.

15. The base station of claim 9 wherein each of the delay components includes an added amount of insertion loss substantially the same as an insertion loss introduced by the corresponding switch.

16. The base station of claim 9 further comprising a tilt control circuit configured to receive an input tilt value and control each of the delay circuits to delay the radio frequency transmit signal such that antenna array generates a radio frequency transmit beam having a tilt based on the input tilt value.

17. A delay circuit for digital remote electric tilt comprising:
a plurality of delay components electrically connected in series;
a plurality of switches, each of the switches electrically connected in parallel with a corresponding one of the delay components; and
a controller configured to control a combination of the switches that are closed and opened to control a tile of the digital remote electric tilt.

18. The delay circuit of claim 17 wherein each of the delay components is configured to introduce a different amount of delay to a radio frequency transmit signal.

19. The delay circuit of claim 17 wherein the controller is further configured to introduce a total amount of delay into a radio frequency transmit signal by controlling the combination of the switches that are closed and opened.

20. The delay circuit of claim 19 wherein the total amount of delay includes a sum of the delays introduced by the delay circuits through which the radio frequency signal travels.
